(19) United States
(12) Patent Application Publication
(10) Pub. No.: US 2014/0310062 A1
(43) Pub. Date: Oct. 16, 2014

(54) SYSTEM AND METHOD FOR ANALYSIS AND FEEDBACK WITHIN A LARGE USER COMMUNITY USING SURVEYS

(71) Applicant: INBOUND CROWD LLC, Falls Church, VA (US)

(72) Inventors: Greg Klein, Falls Church, VA (US); Mike Blinov, Washington, DC (US)

(73) Assignee: INBOUND CROWD LLC, Falls Church, VA (US)

(21) Appl. No.: 14/254,677

(22) Filed: Apr. 16, 2014

Related U.S. Application Data
(60) Provisional application No. 61/812,596, filed on Apr. 16, 2013.

(51) Int. Cl. G06Q 30/02

(52) U.S. Cl. CPC G06Q 30/0203
USPC 705/7.32

(57) ABSTRACT

The disclosed subject matter provides an improved methodology, system, and computer program for offering surveys and collecting and analyzing survey results that allow an organization to generate new surveys in an iterative manner based upon user feedback and crowdsourcing methodologies. In this manner, an organization relying upon survey results can gain greater insight into selected users, clients, and projects. The system according to the disclosed embodiments utilizes crowdsourcing methodologies to collect data from a variety of users and sources, whereby the data can be analyzed using innovative intelligence gathering and management techniques.

### PRIORITY

This application claims the priority benefit under 35 U.S.C. §119(e) to U.S. Provisional Application No. 61/812,596, the subject matter of which is hereby incorporated in its entirety by reference.

### FIELD

The disclosed embodiments relate to a system and associated methods for capturing ongoing user observation and survey responses into a centralized location for analysis and publishing.

### BACKGROUND

Business entities face challenges effectively communicating internally between home office management / marketing staff and both field based customer facing teams and as well as customers. To date, many different mechanisms exist to collect localized market intelligence via email messages, viewing online posts, informal personal communications, traditional market research, etc. Although somewhat effective for understanding localized market information in the moment, none of these systems are established to continually monitor localized market conditions, and the evolution of those conditions, or able to track all of these elements under one integrated system. In addition, many of the systems today do not allow the home office to actively engage, over time, with field teams or customers to post clarifying questions or share back to these audiences what they are learning and acting on. Ultimately, no single system exists today that allows the home office teams to effectively and continually collect information from, as well as pulse questions out to, their field based teams or customers.

### SUMMARY

In view of the deficiencies with open-ended observation capabilities coupled with exiting survey methodologies, the disclosed subject matter provides an improved organizational intelligence gathering and management system executed on an integrated network system combining a client application able to reside on any mobile device or Web page capable for mobile use by field teams, consumers, or clients combined with a centralized Internet site that allows ‘home office’ individuals to systematically and continuously leverage the ‘mass intelligence’ of field based teams. Furthermore, the disclosed system and methodologies allow an organization to generate new surveys in an iterative manner based upon user feedback. In this manner, an organization relying upon survey results can gain greater insight into selected users. The system according to the disclosed embodiments essentially utilizes crowdsourcing methodologies to gather data from a variety of users whereby the gathered data can be collected and analyzed. In other words, data from multiple inputs can be centrally collected and analyzed.

In accordance with the disclosed embodiments, the survey can be presented to end users via a survey application that can be downloaded to a mobile device. The survey itself may include a variety of user interface elements displayed on the user's mobile device that gather the user's responses to questions.

Thus, the disclosed embodiments capture ongoing end user observations and survey responses into a centralized location for analysis and publishing. User communities may be segmented to send and receive unique content via dedicated channels to a specific community. The embodiments are flexible regarding inputs and responses from end users and business users and create ongoing conversations between users that are facilitated by knowledge and functionality within the platform in order to refine the intelligence being discussed and collected. In one embodiment, only surveys and survey responses are exchanged between users and with the platform.

The disclosed embodiments further provide the ability to create and field surveys by unique end user segmentation into a centralized location. The disclosed embodiments also provide the ability for end users to submit free form, or open, observations in the form of text-based messages, photos, graphics, digital documents, hyperlinks, or voice entered messages, for example, back into the system to be made available for other users. In one embodiment, users are scored and ranked based on various behavioral or objective factors and may be automatically segmented into groups based on ranking levels from high to low or other configurable group segmentation factors. In an embodiment, a confidence level or score may be applied to individual user communications so that user communications with a higher confidence level will be given greater weight of reliability than users in a lower confidence level score. The embodiments also provide the ability to publish survey results or observations back out to segmented end user groups. System functionality leverages existing survey responses and history to build from those results to further refine the depth of questioning while maintaining end user continuity and engagement.

The disclosed embodiments may be accessed by a computer for business users and a mobile device for end users, or consumers. Business users of the system may modify and set observation topics. Business users also may generate the specific survey content, including the survey questions and publish learning to a unique distribution group. The content, access level to content and system in general, images and timing of surveys are all customizable by the business users acting in an administrative capacity. The business user can be any organization that is seeking to gather information, including companies, market research agencies, etc.

The disclosed system provides the ability to structure a follow-on survey built from the previous answer surveys to end users based on customizable segmentation criteria. This feature allows for deeper insights via the ability to continue a “story,” or a dialogue, with end users by providing the previous results and then inquiring deeper based on those findings. Further, end users may establish a background or relevance with the line of questioning versus starting anew for each survey. This feature also enables the business users and home office to structure and guide conversations on specific topics that are defined further based on end user feedback.

The disclosed embodiments also allow for additional business users to observe real-time end user observations and survey results by a segmented group for deeper insights. The business users also can search insights, provide feedback, take the observation offline, or recognize any contributors. Business users want to structure and guide conversations on specific topics that are defined further based on received feedback. Such communications preferably happen in secure enterprise environment while being easily accessible by users via mobile devices.

The disclosed embodiments include a functionality component that can be used for internal meetings of specified business end users that leverage the survey and presentation functionality described above. For example, various presentations or other collateral can be embedded into the application that can be visible to the business end users during a specified meeting duration and align with survey questions. A business channel can set up a meeting module for a certain day and time to present survey questions that will align with the presentation or the meeting lead can initiate questions at will. This feature enables the business to share sensitive information between business end users with the ability to provide and remove content and also align/integrate relevant survey questions into the overall presentation flow. Furthermore, the results of active live survey questions can be presented to the business end users in real time on another tab within the module or can be exported in a report for that event.

### BRIEF DESCRIPTION OF THE DRAWINGS

The accompanying drawings are included to provide further understanding of the disclosed subject matter and constitute a part of the specification. The drawings listed below illustrate embodiments of the disclosed subject matter and, together with the description, serve to explain the principles of the disclosed embodiments, as disclosed by the claims and their equivalents.

FIG. 1 illustrates an online environment according to the disclosed embodiments.

FIG. 2 illustrates software managers of the online environment according to the embodiments.

FIG. 3 illustrates a graphical user interface of a dashboard according to the embodiments.

FIG. 4 illustrates an example of surveys according to the disclosed embodiments.

FIG. 5 is a flowchart illustrating a process of the embodiments for gathering intelligence from end user queries and creating additional queries based on the collected data.

FIG. 6 illustrates an end user process of interacting with a system on a mobile device according to the disclosed embodiments.

FIG. 7 illustrates a campaign cycle of the four major steps of the application according to the disclosed embodiments.

FIG. 8 illustrates a process of continual refocusing of survey topics and questions by soliciting real time end user feedback according to the disclosed embodiments.

FIG. 9 illustrates a flowchart for the business user interaction according to the disclosed embodiments.

FIG. 10 illustrates a flowchart for an administrator user in setting content, surveys, observations and other configuration parameters of the system according to the disclosed embodiments.

### DETAILED DESCRIPTION OF THE EMBODIMENTS

It will be readily understood that the components of the present invention, as generally described and illustrated in the, Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention

The disclosed embodiments also provide the ability to display materials and surveys by set user groups and the timeframe for materials to be visible as well as when the surveys expire. The process allows for showing total end user survey response activity after the immediate end user completion of a question or series of questions.

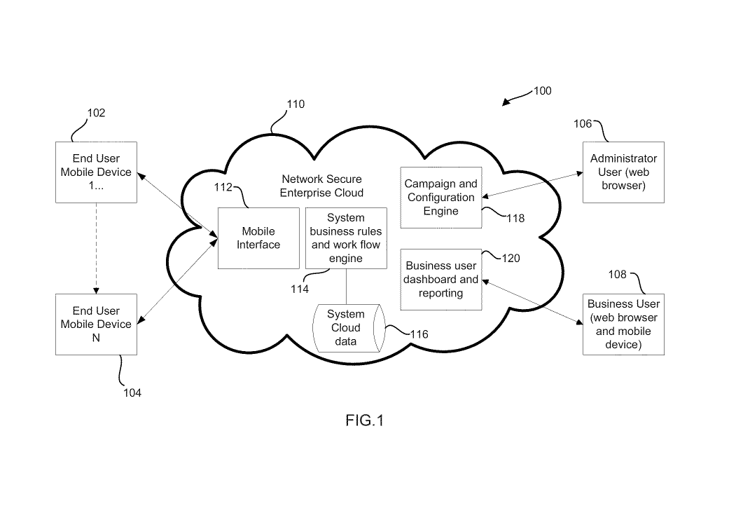

FIG. 1 depicts an exemplary network environment 100 in which various embodiments of the present invention may be implemented and function. Online environment 100 is a system in which dynamic surveys, observations, and other content are created and transmitted to end users on mobile devices with business and administrative users having the ability to see the results and configure accordingly. Online environment 100 may be hosted over a network of connected devices, preferably mobile devices, which encode data into machine-readable form and transmitted between devices. Thus, online environment 100 also may be referred to herein as “the system” or a “platform.” Secure network enterprise cloud 110 may include one or more servers, networks, processors, interfaces, media, displays, and mobile or desktop computing devices that are capable of executing the features and functions of the embodiments described herein. Network 100 may include any suitable interconnected communication system, such as a local area network (LAN) or wide area network (WAN) for example. Network 100 may implement any suitable communications protocol and may be secured by any suitable security protocol. The corresponding network links may include, for example, telephone lines, DSL, cable networks, T1 or T3 lines, wireless network connections, or any other suitable arrangement that implements the transmission and reception of network signals.

Network environment 100 includes one or more end user client computing devices, for example, a client 102 and a client 104. Examples of the one or more clients may include but are not limited to a computer, a laptop computer, a mobile/smart phone, or a personal digital assistant (PDA). In the embodiments, elements of mobile crowdsourcing clients are illustrated such as end user mobile device 102, which may be connected to the Internet, an intranet, cellular network, or any suitable communications network that allows device 102 to communicate with mobile interface module 112. In an embodiment, platform 100 includes a dedicated communications channel for end users to communicate with cloud system 110 through mobile interface 112, other end users, and business users 108. End user mobile device 102 includes the capability to receive queries through the communication channel and respond by submitting observations and participating in surveys. Online environment 100 may include any number of end user mobile devices. Thus, end user mobile device 104 represents a second or a plurality of mobile device(s) “N” having the same or similar functionality and capabilities of end user mobile device 102 for receiving surveys/queries, submitting responses and observations, and reading news articles. End user mobile devices 102 and 104 exchange information via mobile interface 112 within network secure enterprise cloud 110.

In an embodiment, administrator user 106 configures the system through a computer connected to network secure enterprise cloud 110. Alternatively, administrator user 106 may access online environment 100 over the Internet via a web browser. Administrator user 106 also receives instructions from business user 108 on content and configuration of the system. Through a system administrative portal, administrator user 106 configures the system to impact what an end user views on end user mobile devices 102 and 104. System administration allows the defining and creation of different client user groups based on geography, role, behavioral elements, etc. These groups would be used through the portal 110 in terms of how portal users can drill down into analysis of survey responses and open-ended user observations. Administrator user 106 may exchange information and perform configuration operations via campaign and configuration engine 118. All data elements from the portal can be exported into standard software packages (PowerPoint®, Excel®, etc.): survey summaries, open ended user observations, user statistics, etc.

Business user 108 defines the content of surveys to be sent to the end user mobile devices 102 and 104. Business user 108 receives the output from the system on surveys and observations that provide aggregate information input to MyLearning articles. An end user reading content through mobile device 102 can gain from knowledge received through “MyLearning articles.” As used here, “MyLearning articles” refers to summary articles that can be provided to the end user relating to various topics, including information about the prior queries/surveys, prior query/survey results and prior observations from various end users. Business user 108 gains from end users' understanding of the market. Business user 108 may access online environment 100 via a web browser, direct network access through an application, or via a mobile device.

Business user 108 may further interact with administrator user 106 to provide content for queries, surveys, observation categories, and MyLearning articles. Business user 108 also analyzes the query/observation/survey results dashboard 120 to gain further knowledge from data collected from the end user perspective. Business user 108 sends follow up communications to end users on interest of topics. In another embodiment, only observations are exchanged between users and with the system. In yet another embodiment, a mix of surveys, responses, and observations are exchanged, however one project or conversation may be primarily driven by surveys while another may be primarily driven by observations. Information and feedback received from the end users 104 can be used in an iterative manner by other end users and business user 108 to develop further surveys, inspire new observations, and request further information in an effort to refine and gain confidence in information and intelligence for the project.

In addition to a plurality of end users 104, a plurality of business users 108 also may participate in online environment 100. One or more additional business users correspond to business user 108 who may be a central office user who also accesses the dashboard reporting 120 through a graphical user interface (GUI) to review real-time observations and survey results to gain further understanding and insight of events, information, opinions, and data generated from end users in the field. The business users utilize the work flow engine 114 to access the end user population of observations and survey results held by database 116. Business users 108 may also design new queries/surveys, perform analytics on aggregated data 116, provide thank you notes, rate the quality of the observation, follow up further with end users 104, or move a conversation offline. Furthermore, a first business user 108 could also interact with other business users to provide feedback to the first business user regarding query/survey effectiveness and optimization.

In one embodiment, various business users can also view presentations during a specified meeting duration and align with survey questions. This allows an organization to share sensitive information between business end users with the ability to provide and remove content and also align/integrate relevant survey questions into the overall presentation flow.

Network secure enterprise cloud 110 also includes system business rules and work flow engine 114, which accesses system cloud data 116. Engine 114 monitors and facilitates the exchange of information within online environment 100. Engine 114 may execute programmable computer instructions, and store results from surveys and observations within cloud data 116.

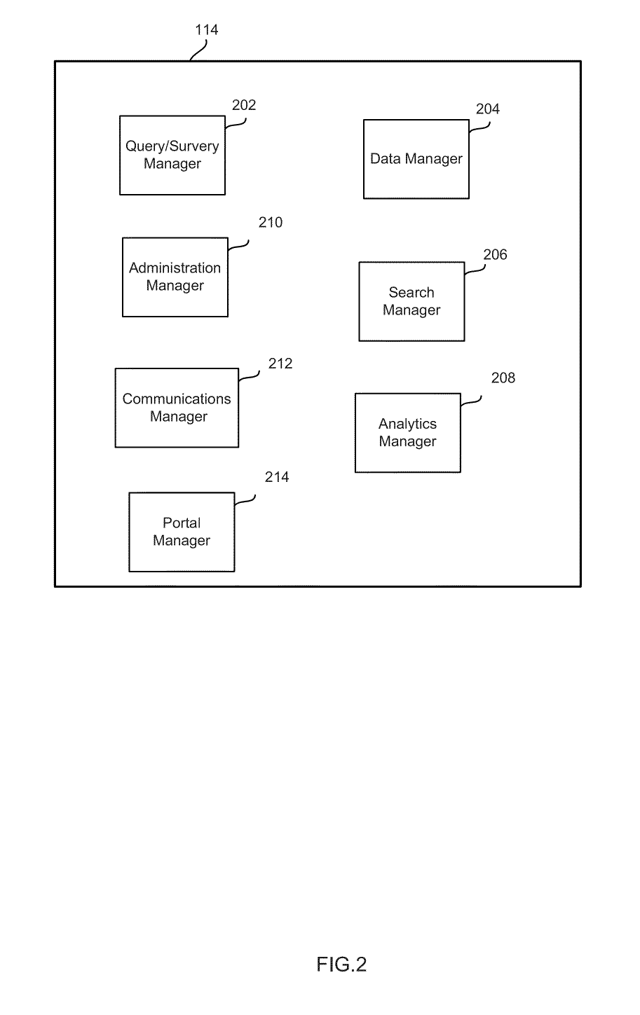

FIG. 2 illustrates embodiments of managers 200 for work flow engine 114. The functional units described in this specification have been labeled as managers and directors. A manager and/or director may be implemented in programmable hardware devices such as field programmable gate arrays, programmable array logic, programmable logic devices, or the like. The manager and/or director may also be implemented in software for execution by various types of processors. An identified manager and/or director of executable code may, for instance, comprise one or more physical or logical blocks of computer instructions which may, for instance, be organized as an object, procedure, function, or other construct. Nevertheless, the executables of an identified manager and/or director need not be physically located together, but may comprise disparate instructions stored in different locations which, when joined logically together, comprise the manager and/or director and achieve the stated purpose of the manager and/or director. Indeed, a manager and/or director of executable code could be a single instruction or many instructions and may even be distributed over several different code segments, among different applications, and across several memory devices. Similarly, operational data may be identified and illustrated herein within the manager and/or director, and may be embodied in any suitable form and organized within any suitable type of data structure. The operational data may be collected as a single data set, or may be distributed over different locations including over different storage devices, and may exist, at least partially, as electronic signals on a system or network.

System 100 has the ability to dynamically and adaptively present survey questions. Referring further to FIG. 2, query and survey manager 202 includes logic that performs the functions related to creation of queries and surveys, and management thereof, by business users and end users and other functions described by the embodiments. For example, the system 100 has functionality that allows the system administrator to load complex survey structures that only present certain surveys to respondents that answers previous surveys in a certain way (e.g. first question: do you like dogs, cats, or fish; second question: (80% of users previously answered dogs) . . . what kind of dog . . . small, medium, large?; third question: what type of large dog . . . ). The system can present end users with visual historical survey answers that provide continuity in the process of asking follow on questions to increase understanding and accuracy of response.

Data manager 204 includes logic that manages system cloud database 116 and other data management functions described in the embodiments. Search manager 206 includes logic that manages the functions of the embodiments providing capability to search key words and similar terms within end user feedback and observations and other search features described in the embodiments. Analytics manager 208 includes logic that provides the functions and management of analyzing query/survey responses. Additionally, portal 120 provides an ability to review all current and past surveys. The system also allows the user to see the differences in survey responses based upon different defined user groups (e.g. territories, districts, regions, system generated segments, etc.) side by side and use search data to identify trends as well as other analytical features described in the embodiments.

Systems capability and management manager 210 enables ‘home office’ or business users with the system capabilities include the ability to build adaptive and dynamic survey campaigns, automatically segment respondent audiences based on survey responses, and determine confidence level of responses based on time to respond. Analytics manager 208 has functionality to score different surveys in terms of a confidence score that is determined based upon how quickly respondents are answering the survey questions presented (i.e. the shorter the time on average for an answer, the more confident individuals may be in their responses). This confidence data is displayed in conjunction with the survey results in the portal's dashboard interface 120.

In addition, system administrative capabilities allow manual setup of user groups, content load, and ability to establish an on-demand, temporary environment for special events/times. The Internet Portal is able to be customized to recognize a user and show only areas or content relevant to that user. This allows the system administrator to compartmentalize different groups or teams. In addition, the sign-on authentication process can be integrated into normal corporate security policies to achieve a ‘single sign-on’ approach (e.g. the system recognizes a corporate user based on their IP address or other industry security token or protocol like SAML, Active Directory and etc.).

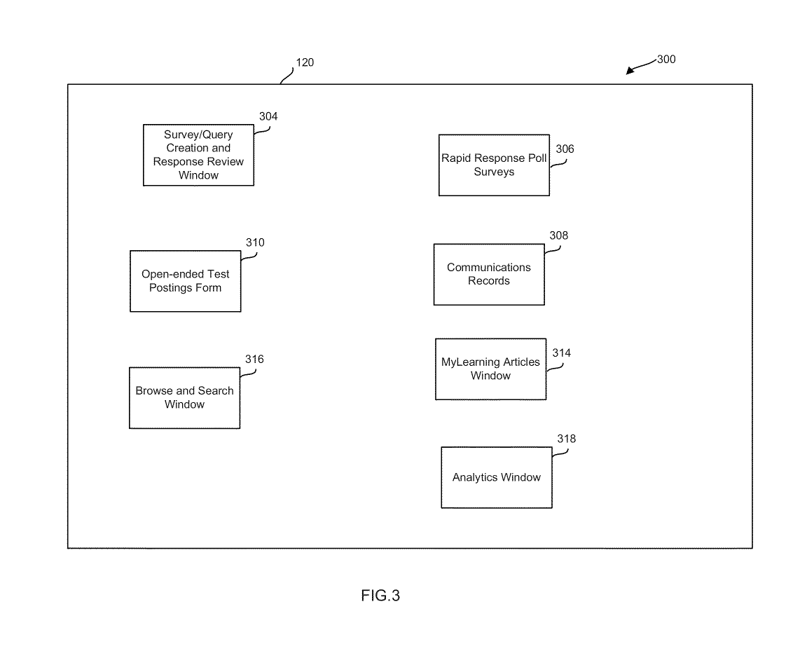

The internet portal incorporates several distinct elements for ‘home users’ understanding current status of mobile client engagement and deriving insight from the system: 1) real-time results of all survey responses; 2) real-time display of all open ended user observations in text fields submitted; and 3) usage statistics of the field teams. All data elements are able to be parsed, filtered and sorted. The main page of the internet portal consists of a customizable and role driven dashboard that visualizes and reports real-time summaries of all open surveys, open-ended user observations in the form of text submissions and other ‘home office’ users views on specific user observations, learning/news section, and client app user statistics. FIG. 3 illustrates an embodiment of dashboard platform architecture in accordance with the present disclosure. In the illustrated embodiment, a business user 106 or end user 102 can access various aspects of dashboard and reporting module 120 across network 100 using a graphical user interface (GUI). Dashboard 120 may exist on a server, cloud server, or any appropriate system architecture as described herein or known to one skilled in the art. Features of dashboard platform 120 include query or survey creation and review 304 which can function as a UI to survey manager 202. Rapid response poll surveys 306 UI provides a simplified and instant results window for users and allows a central office to probe and gain rapid responses from the field to key topics being pursued. Exemplary open ended observations and postings UI 310 provide a semi-structured approach to collecting open ended feedback from end users and captures history of end users' past observations. In an embodiment, Internet portal 120 a user may access the following tabs to enter or view real-time data: Portal Feedback, Survey Ideas, and News Article Ideas. The embodiments support portal users to quickly capture ideas or thoughts they have in the field and drop them into an exemplary intelligence category. From these categories, different users or designers can review the comments to develop future portal improvements, surveys, articles, or reply with their own observations. In an embodiment, any time a key (and associated) word is submitted via the client application as an open ended observation, an email notification will be sent to the portal user that includes the comment. The system will also provide a link back into the internet portal offering to show the portal user other comments like the one being presented based on similar key words. In another embodiment, when a comment is received based on tagged key words, a desktop application that constantly runs in the background pops up the comment and allows it to scroll across the screen, similar to news channel banners that float along the bottom of the screen showing updated items.

A key component of the internet portal is the word cloud interface component that allows home office users to dynamically and effectively search for and tag key words while also being able to ‘surf’ through the various open ended user observations and other text comments based on word prevalence and relationship between prevalent words. By clicking on any words in the cloud, the list of the comments generating that key word show up which the user can then click on and jump to in order to read the entire comment. Further, in an embodiment the word cloud has the capability to run against a timeline so the user can watch how the top words change over time based on the comments coming in. In addition, the portal users can click on any word showing in the cloud and gain access to the comments that are stimulating that word to show in the cloud. Portal users can also tag that word and add it to their customizable alert list. Portal users can also search the open ended user observations via the cloud by entering a word or set of words and the cloud displays not only that word/words but all the most closely related words. The reason for this capability is that searching for a specific word may miss many related comments because a synonym or short form of the word was used in a comment.

The portal users have the ability to easily click on the submitters name to send a follow up email inquiry to ask for further clarification. In addition, the word cloud interface is leveraged against the user observations submitted by end users on a survey topic or any other relevant topic that allows users to ‘surf’ through comments based on frequency or search interests as well as ‘tag’ key words to create an alert list.

The embodiment further provides a central office an opportunity to gain an ongoing stream of local market observations around key topics. A record of communications published back out to end users is provided by UI 308. The communications are centered on what a central office is hearing from end users and what action the office is taking on the communication. Communications record UI provides advantages of an ability to share short articles on progress being made on sales or other project as well as key initiatives being pursued. It also provides a space to recognize participants to drive further engagement. In exemplary surveys UI 318 for workflow engine 112 surveys manager 202 provides a user the ability to browse and respond to a number of surveys, which are a compilation of questions on a topic of interest for a particular business user. The module shows time remaining to complete for open surveys. Completed surveys are available to browse through questions to determine the percentile distribution of other end users' responses to multiple choice questions. The system expects the user to browse surveys that are questions grouped by topic, to identify unanswered surveys and answer the questions, and to observe the distribution of the responses from other users on completed questions.

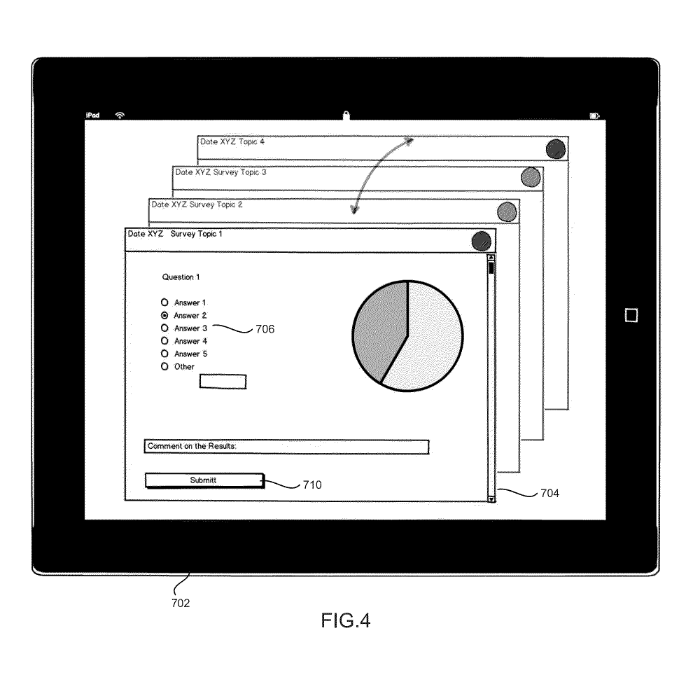

Further functions of the surveys UI 318 relates to answer a survey question. End users access the module 318 and open a question within a survey file. The user selects a question to answer so that the system can capture the user input. End user answers the question, and after answering the question, the software may alternatively provide a chart illustrating other users' answers selections for the same questions thereby providing immediate feedback from other end users. The platform may alternatively display only a percentile distribution of answer choices by other users instead of the exact answer for each user. Referring to FIG. 4, multiple surveys 704 are presented to the end user's mobile device 702 with the newest survey shown on top. Each survey has a capability to color code previously answered surveys, a countdown of survey availability and end results that either already expired or have been answered by the end user. The disclosed system also allows the end user to browse through available surveys as well as respond to them. Each survey includes a variety of multiple choice questions 706 including free text fields 708 for the entry of observations. When a user has completed a survey, he or she selects a “Submit” button 710, which transmits the data from the survey to the network system 100 for saving into database 116.

Exemplary observations module UI 310 provides end users the ability to display and review his or her prior observations and notes regarding a query, survey, or any other topic. End user may select a topic of a new observation from a list and enter an observation on the topic using a text entry interface. A user may select pre-defined topics of interest and input new observations that can be captured in the platform system. Exemplary search and analytics module UI 316 provides an interface for the user search manager 206 in order to search text from all observations from all users. Analytical analysis may also be performed on query responses and user observations.

Exemplary My Learning module UI 314 provides end users the ability to browse and review news and/or article postings by category. Users may observe a learning summary, review content of the news articles, and review content of articles written by other users.

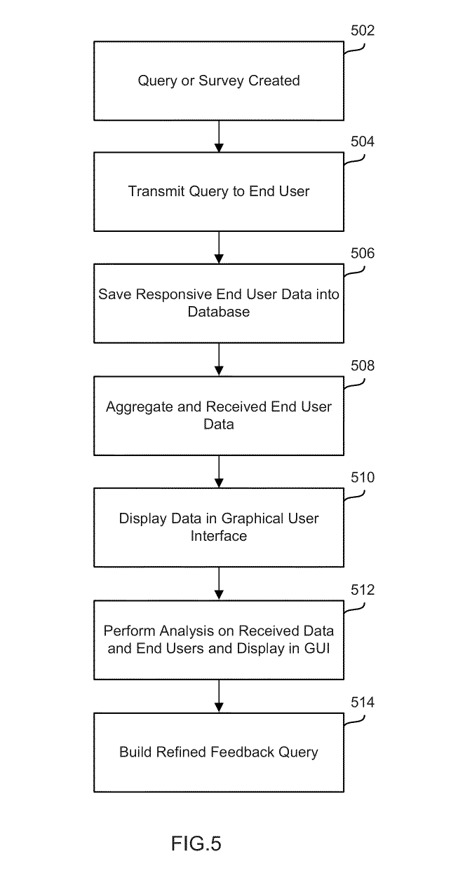

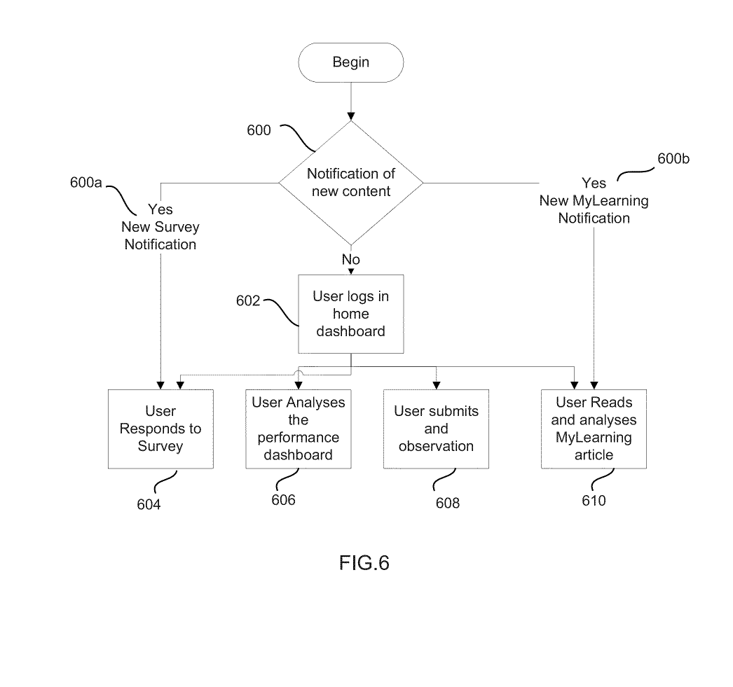

FIG. 5 illustrates an exemplary method to execute or perform the features of the embodiments. Process 500 may be executed using the elements disclosed within FIGS. 1 and 2, and reference to these elements may be made for illustrative purposes. The method is directed towards gathering organizational intelligence using crowdsourcing methods of a plurality of end users providing information and responding to the queries, which are collected in a central data repository. Further details of preferred and alternative embodiments are illustrated and explained in FIGS. 6-10. In FIG. 5, an exemplary method for organizing crowdsourcing intelligence is illustrated. In step 502 a query, or survey, is created using a workflow engine 114 on a platform server 110 according to business rules that define entities such as end users.

Business rules can define what types of data are collected, such as open-ended user observations, survey answer selections, and other type of information relevant to obtaining intelligence, and a timing of when the data is to be collected. Step 504 executes by transmitting the query from a central portal to group or plurality of end users that may use computers or mobile devices to receive and respond to queries. A number of end users enter information into the query fields and transmit the entered data back over a network such as the Internet to the central portal, where in step 506 where the data is saved into a database. In step 508, received data is aggregated by the workflow engine 114, analyzed by an analytics manager 208, and stored in a database 116. Step 510 displays the aggregated data in various formats within a graphical user interface formed as a dashboard. In an embodiment, end user data is displayed in real time as it is received from an end user mobile device. Step 512 analyzes the received data according to business rules and intelligence needs. In an embodiment, analysis includes searching for trends in observations or query responses, and segmenting groups of end users according to data indicating behavioral aspects of end users. In another embodiment, users may be scored or ranked according to human behavioral factors. An exemplary scoring system could rank users by taking into account such factors as prior success in field marketing, feedback from clients and colleagues, knowledge of the product, experience in the company or industry, education, engagement level with the platform and reliability of responses. Still other behavioral aspects of data collected from end users could include how quickly surveys were answered correctly, does the user submit substantive and relevant observations, and did the user submit a common answer or observation consistent with other users. In an embodiment, higher ranked users based on elements of behavioral traits are segmented from lower ranked users. In other embodiments, new users of the platform or users on a new project are ranked and segmented based on responses from initial survey questions. Generally, the platform will consider the higher ranked users as providing more reliable observations, responses, and intelligence from the field. Further, users may be ranked in various categories that can overlap such as high, medium, or low reliability; fast, normal, slow response times; and consistent or inconsistent provider of observations.

Step 514 provides for a user to build one or more refined feedback queries that may be sent to users to gather more specific information or alternatively to broaden the request for additional information not realized in the prior survey, which can be based on the analysis of the aggregated data in step 512. In an embodiment, data related to questions are analyzed including responsive answers, end user behavioral information, and objective end user data. Exemplary information include response time of users, location of end users or client location at the time of providing responses, time of day of responses, and speed of responses from the time a query has been transmitted to mobile devices.

Other embodiments analyze end user behavior to provide user group behavioral segmentation. System has functionality that allows for respondent segments to be identified based upon their responses, or alternatively, pre-defining client groups of users based on role, geography, client activity, etc.

Additional analytics, such as searching open-ended text comments, unstructured text, and text analytics that will break down words and look for key words are directed to creating a word cloud as an intelligence reference database. For example, a search of the word cloud could result in how many responses include the terms “diabetes.” Portal users, via the word cloud, will have the ability to tag key words. In addition, a library evolves with each user group to capture relevant word groups. As an example, if a user enters “physician” as a key word, the word cloud automatic search and analytics will also pick up synonyms, word variations, and corresponding terms such as doctor, doc, nurse practitioner, prescriber, etc. Also, when a word is tagged, the system will offer up other like words that are related, but not necessarily synonyms for the tagged word. Proprietary libraries evolve over time with different users groups that allow users to more effectively keep track of key issues they are interested in without having to think up every term that could be related to that issue. For example, if a user enters the term “diabetes,” the system will capture glucose intolerance, sugar, metabolic syndrome, etc. The development of this library requires significant back end analytics to establish.

Referring to the flowchart in FIG. 6, an embodiment of end user interactions with system 100 is illustrated. Step 600 executes by notifying an end user of new content. The end user also may execute this step by simply opening a client-side application installed on mobile device 102 or alternatively a client or browser application on a computer that connects to enterprise network environment 100 through mobile interface 112. In a preferred embodiment, a mobile application is installed on mobile device 102 that comprises a user dashboard that provides participants with various engagement statistics and current user rankings based on utilization of the following, an ‘insta-poll’ mechanism that allows field based users to see the accumulated results of answered survey questions in a campaign, prompted open-ended survey fields, and a ‘news reel’ that allows the central, home office to communicate back to field teams comprising end users via short articles that are easily opened and read on the mobile device 102.

In one embodiment, the mobile application includes a self-registration component that ties into corporate security protocols and allows self-identification of which user group the end user 102 belongs to. The feature eliminates a large portion of work that would normally be required by the system administrator if they were to manually load in all mobile application users. The end user 102 may need to enter security login credentials based on specific security access policy. Step 600 also may determine whether the end user accepts the notification. If yes, then step 600a or step 600b may be executed depending on the type of notification.

Step 600a executes when the end user receives a new survey notification. After logging in, the end user is taken to step 604 to respond to the survey. Mobile application has the capability to visualize close or open ended survey questions, which, when answered, immediately show the cumulative results of all responses to date. In addition, users can go back to survey questions at a later date and the survey responses will continually update with responses through that point in time. The capability to answer survey questions exists both on and off-line, allowing the user to access the system when not connected to the internet. Further, in an embodiment the system has the ability to establish a temporary on-demand environment. Home office' users can schedule and turn on a temporary place in the mobile application to present a PowerPoint style presentation and set of accompanying survey questions and open ended text prompts to be used for specific periods of time (e.g. during sales meetings or event to get specific feedback on the meeting topics).

Step 600b executes when the end user receives a new MyLearning notification. Articles may be presented to the end user based on survey results. Thus, step 610 executes by having the end user read and analyze MyLearning article. Mobile application has a section that lists out different ‘articles’ in a news service type of format (block tiles) that the user can touch to open. Once a tile is touched, a short story along with any visuals loaded into the system will be portrayed. This ability allows the home office to share any actions they are taking based on intelligence received to date, to share news relevant to the client users, or to highlight either specific surveys or open ended topics

If the user does not accept or use a notification, then step 602 executes by having the end user log into the home dashboard. From the home dashboard, the end user may select from several options. An end user dashboard that provides participants with various engagement statistics and current user rankings based on utilization of the system. A unique scoring and ranking system based upon response time and completion of survey questions and number of open ended text submissions. The exemplary system can display individual or various team rankings, can be reset on a regular basis so there are quarterly, monthly, etc. competitions allowing for various rewards and recognitions to be provided. In additional embodiments, home office portal users have the ability to ‘like’ different comments and also ‘follow’ individual specific client application users. How many likes or followers a client application user has will be displayed on the end user-client application dashboard. The end users' dashboard displays how many ‘followers’ and ‘likes’ each user has accumulated is used by the business users to acknowledge end user participation with observations and that feedback entered into the system is being reviewed and studied. A notice for a survey campaign status provides the end user with visibility into all live surveys and percentage complete based on their activity on answering those surveys. Lastly, summarizes current read versus unread content currently posted within the client application. The end user may select to execute step 602 or 605 disclosed above. Step 606 executes by analyzing the performance dashboard to check results and statistics. Step 608 executes by submitting an observation to the system from the end user. An exemplary mobile application has a section that portrays key topics for the client users to ‘keep their eyes/ears open for’, then provides an area for them to provided extended text commentary around these topics for observed events on a repetitive basis (e.g. a user may submit multiple observations against each topic portrayed). All of these steps may be execute upon receiving an instruction input from the end user into a mobile device.

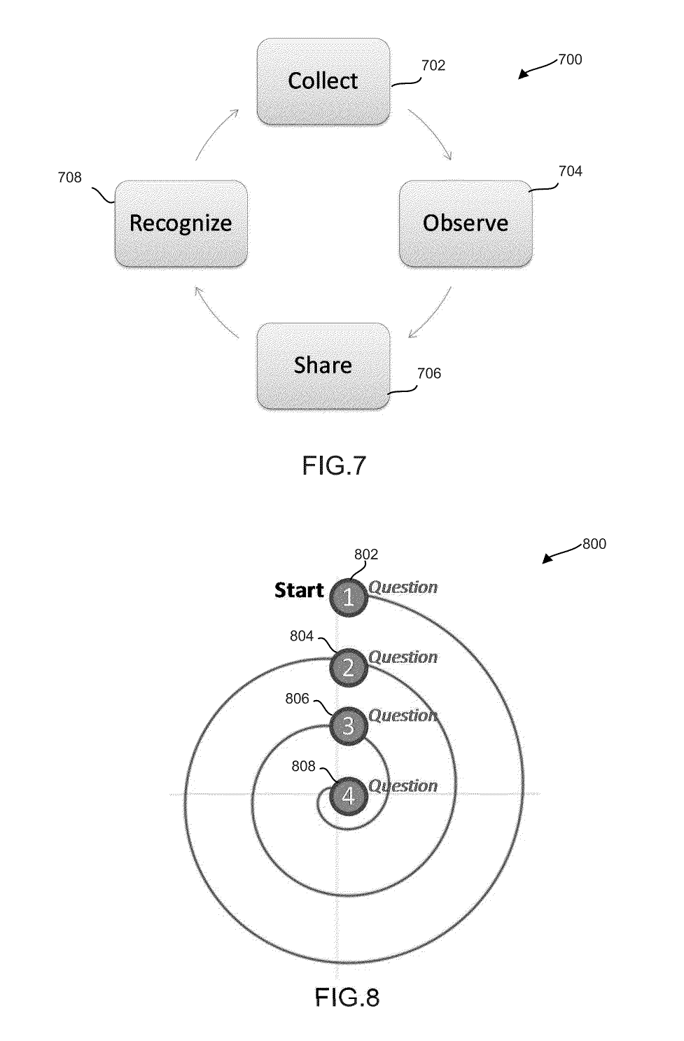

FIG. 7 depicts a campaign cycle 700 of the four major steps of the application according to the disclosed embodiments. Campaign cycle 700 may represent the iterative steps taking during the survey processes using online environment 100. Any of the steps may be executed first, and the cycle may continue and may stop at any step. Step 702 executes by collecting survey data and information. Step 704 executes by observing behavior and actions online using interfaces and mobile device actions.

Step 706 executes by sharing the collected and observed information with other parties within, for example, online environment 100. Other parties may include administrator user 706 and business user 108. Step 708 executes by recognizing additional potential subjects for surveys or additional information based on the information. Cycle 700 then returns to step 702 to collect this additional or new information, and so on. To promote mobile client application continuity in survey evolution, when presenting surveys, system has the capability to provide previous survey question results/history in order to provide context for follow on questions. This capability allows client application end users to follow along in the story development.

FIG. 8 depicts a process 800 of continual refocusing of survey topics and questions. Process 800 accomplishes these features by soliciting real time end user feedback during the process to generate more engaging specific discussions and deeper insight from the population of end users, as with a plurality of mobile devices. Process 800 may execute in conjunction with cycle 700.

Process 800 starts with question one 802. An end user answers question one, so that the disclosed system collects this information. The disclosed system observes the answer and other factors with the answer, such as time to answer or other information. The disclosed system then shares the answer to question one. The disclosed system recognizes additional information based on the answer and proceeds to question two 804. The end user, using a mobile device, answers question two 804. The cycle is executed for question two, which proceeds to question three 806. After answering question three, then process 800 identifies and proceeds to question four 808. Thus, process 800 constructs a path through relevant questions presented to the end user so that the end user is engaged during the survey process.

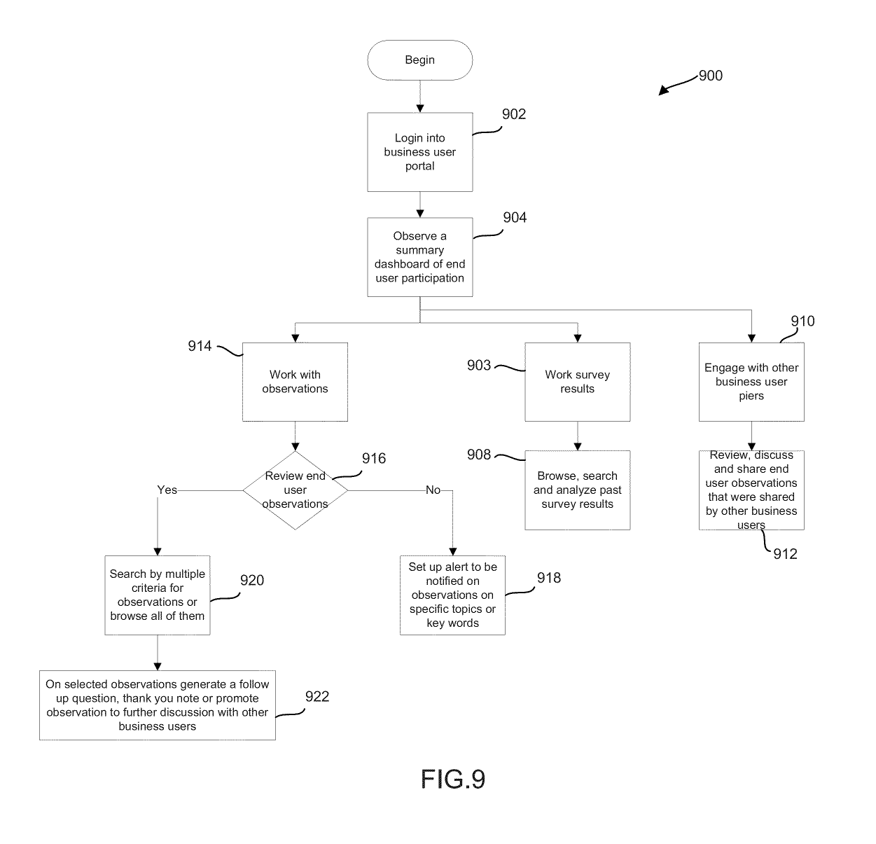

FIG. 9 depicts a flowchart 900 of business user 108 interaction with the system according to the disclosed embodiments. Step 904 executes by logging into the business user portal over the system. Step 904 executes by observing a summary dashboard of end user participation. Business user 108 then may select from different steps using the dashboard to analyze results. Step 906 executes by identifying work survey results. Step 908 executes by browsing, searching and analyzing past survey results.

Step 910 executes by engaging with other business user peers over the network. Step 912 executes by reviewing, discussing and sharing end user observations that were shared by other business users. In other words, more information is made available to guide the survey process.

Step 914 executes by working with observations compiled during the survey process. Step 916 executes by reviewing end user observations and determining whether any observations are of interest. If no, then step 918 executes by setting up an alert to be notified on observations on specific topics or key words. If yes, then step 920 executes by searching by multiple criteria for observations or, alternatively, browsing all observations. Step 922 executes by generating a follow up question, as shown in FIG. 8, based on selected observations. Alternatively, step 922 may generate a thank you note or promote an observation to further discussion with other business users. It should be noted that the business user 108 can create and or direct further surveys based upon on earlier survey results and observations.

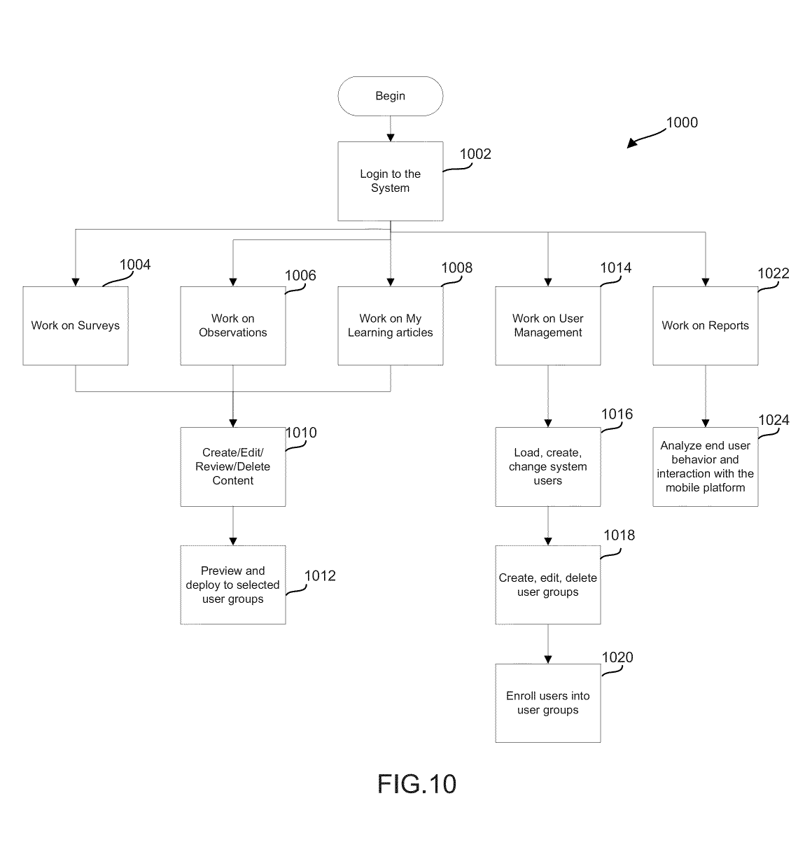

FIG. 10 depicts a flowchart 1000 for administrator user 106 in setting content, surveys, observations and other configuration parameters of the system according to the disclosed embodiments. Step 1002 executes by logging into the system by administrator user 106 using a web browser. Administrator user 106 then may select several different functions or actions to take.

Step 1002 executes by working on surveys, as selected by administrator user 106. Step 1006 executes by working on observations. Step 1008 executes by working on MyLearning articles. Administrator user 106 undertakes these actions and works on these items. After completing these one or more of these task, step 1010 executes by creating/editing/reviewing/deleting content related to surveys, observations or MyLearning articles. Step 1012 executes by previewing and deploying the content to selected user groups.

Step 1014 executes by working on user management. This branch of flowchart 500 relates more to managing groups and users allowed within the system. Step 1016 executes by loading, creating, or changing system users. End users may be dropped or added, as desired. Step 1018 executes by creating, editing, or deleting user groups. Step 1020 executes by enrolling end users into user groups. Step 1022 executes by working on reports. Step 1024 executes by analyzing end user behavior and interaction with the mobile platform. As opposed to surveys, these actions look at how end users use their applications. Examples may be frequency of use, average time spent on the mobile device platform, and the like.

In a non-limiting businesses-to-business embodiment of the embodiments, the methods, systems, and computer programmed logic, the embodiments are used to gain intelligence and understanding of the perspective of health care professionals and their views on a product and support attributes. This embodiment is intended to be merely an exemplary use of one type of implementation, and it should be understood to one skilled in the art that the present invention and its embodiments are not limited to use in the health care field or limited to any field of use, industry, or commerce. In the example, end users are categorized as fifty pharmaceutical field service sales representatives (“sales reps”), business user is a sales manager at a central home office for the pharmaceutical company, and customers are doctors, nurse practitioners, clinics, and hospitals within a multi-state region of the United States. The sales reps use a tablet computer as their primary mobile device. Tablets are connected to the Internet either by Wi-Fi or cellular dial-up modems whenever either service is available. Crowdsourcing platform system 100 has been installed at the home office, and the sales manager and each sales rep can log in and utilize the features and functions of the embodiments described herein. The pharmaceutical company is gathering intelligence relevant to a new type of statin drug that it gained approval to sell by the FDA. The company is interested in competitive market intelligence of medical professionals' perception of the drug relative to patient population.

As an initial step, the sales manager sends out a survey to the sales team that queries the frequency of prescription of the drug, what competitor drug are the doctors or hospitals prescribing, the locations of doctors or hospitals/clients that are prescribing the company's drug, the doctors' perception about the company's drug (and/or other similar drugs, if relevant), and patient population in the corresponding locations . Approximately ¾ of the sales reps provide responses to all of the categories and questions within three days and all of the reps provide responses within two weeks. Of the group answering within three days, half are visiting doctors and nurses in hospitals and the other half private offices or clinics. The online network system analyzes these initial behaviors and responses and categorizes the sales reps into groups based on time to provide a response to all questions (all those with responses in three days or less) and further subcategorizes this group by location of origin of responses provided (hospital or private clinic in a city, county, or state). Survey questions are sent to sales reps to determine doctors' perceptions about the statin drug and opinions about supporting attributes of the manufacturer. Responses from all reps and real-time location data from their tablet location history are received into the central server and analyzed. The system dashboard graphically depicts areas within centers of large metropolitan areas as well as rural areas within a state have the highest prescription usage. Further surveys are sent to sales reps to gather more information about why the variation in usage occurs geographically. One sales rep meeting with a doctor in Atlanta, for example, heard that the doctor has a positive perception of the drug's effectiveness, and the doctor told the rep anecdotally that she had a couple of patients on statin drugs who developed diabetes that otherwise were not at risk for the disease. The sales rep enters the anecdote as an observation, which is tagged for containing the term “diabetes” along with the location of the doctor and is transmitted back out to sales agents. Other agents read the open observation and then enter own observations of similar statements made to them by doctors, such as patients developing comorbid diabetes. Some of the sales reps entering further observations are scored higher than others in behavioral categories or location, and these sales reps are segmented into a group. The system automatically gives greater weight and confidence to observations and responses from the highly scored agents in the new group than the information transmitted by lower scored agents. All the data being collected begins an ongoing conversation among sales reps and the sales manager that helps identify trends in locations, doctor perceptions and , and possible side effects. However, system determines that the data from all surveys and observations regarding perceptions of the drug, locations of use, and open conversations from the highly scored group is the information that should be analyzed by the central platform database. Analytics is performed on the group data in order to gain intelligence of medication perception based on geographic location and type of doctor and/or facility, views on company support and competitor drugs, and insight into information shared by doctors that would not be have been captured into prior survey systems.

In an additional non-limiting businesses-to-consumer embodiment of the embodiments, the methods, systems, and computer programmed logic of the present invention, the embodiments are used to gain intelligence and understanding of the perspective of consumers of a type of mobile smartphones and their views on the product and support attributes. This embodiment is intended to be merely an exemplary use of one type of implementation, and it should be understood to one skilled in the art that the present invention and its embodiments are not limited to use in the telecommunications products, services, or computing fields or limited to any field of use, industry, or commerce. In the example, end users are categorized as field service sales representatives (“sales reps”, “agents”), a business user is a sales manager at a central home office for the smartphone company, and customers are retail buyers within a multi-state region of the United States either through retail stores or a cellular telephone service website. The sales reps use a tablet computer as their primary mobile device. Tablets are connected to the Internet either by Wi-Fi or cellular dial-up modems whenever either service is available. Crowdsourcing platform system 100 has been installed at the home office, and the sales manager and each sales rep can log in and utilize the features and functions of the embodiments described herein. The smartphone company is gathering intelligence relevant to a new smartphone it has just launched for sale. The company is interested in competitive market intelligence of as it relates to buyers' perception of the new product and service attributes relative to the competitive smartphone industry overall.

As an initial step, the sales manager sends out a survey to the sales team that queries the frequency of purchase of the smartphone, features of the phone that prompted the purchase, buyers' perceptions before purchase and after purchase, competitor sales agents and manufacturers' reactions and perceptions of the phone, the locations of retail stores and buyers, and perceptions of cellular service companies hosting the phone on their networks. Approximately ¾ of the sales reps provide responses to all of the categories and questions within three days and all of the reps provide responses within two weeks. Of the group answering within three days, all are visiting retail stores and speaking with buyers directly as well as gaining feedback from online buyers. The online platform of the embodiments analyzes these initial behaviors and responses and categorizes the sales reps into groups based on time to provide a response to all questions (all those with responses in three days or less) and further subcategorizes this group by location of origin of responses provided (in a city, county, or state). Survey questions are sent to sales reps to determine buyers' opinions about the smartphone features and supporting attributes of the manufacturer. Responses from all reps and real-time location data from their tablet location history are received into the central server and analyzed. The system dashboard graphically depicts areas within centers of large metropolitan areas, mid-sized cities or towns, and rural areas within a state that have the highest smartphone sales and usage. Further surveys are sent to sales reps to gather more information about why a variation in usage occurs geographically. One sales rep meeting with a sales agent at a cellular service retail store in San Francisco, for example, heard that the buyers at the store generally have a positive perception of the phone's features, but the agent mentioned that a few buyers decided not to make a purchase because they had read online reviews that the battery life was rated the lowest out of all new smartphones on the market. The sales rep enters the anecdote as an observation, which is tagged for containing the term “battery life” along with the location of the retail store and the information is transmitted to the platform server through the platform's dedicated communication channel. Other agents read the observation and then enter own observations of other statements made to them by sales agents and buyers regarding battery life. Some of the sales reps entering further observations are scored higher than others in behavioral categories or location, and these sales reps are segmented into a group. The system automatically gives greater weight and confidence to observations and responses from the highly scored agents in the new group than the information transmitted by lower scored agents. All the data being collected begins an ongoing conversation among sales reps and the sales manager that helps identify trends in locations, buyer perceptions, and possible defects that could lower battery life. However, the platform analytics determines that the data from all surveys and observations regarding battery life, locations of smartphone use, and such information as to whether the phone is used heavily to access the internet, etc. from the highly scored group is the information that should be analyzed by the central platform. Analytics is performed on the selected group data in order to gain intelligence of battery life and buyer perceptions based on geographic location, type of buyer, use of the smartphone, views on company support, and insight into information shared by retail agents that would not be have been captured into prior survey systems.

The computing device on which the mobile survey system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on. The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

It will be apparent to those skilled in the art that various modifications and variations can be made in the disclosed embodiments of the disclosed device and associated methods without departing from the spirit or scope of the invention. Thus, it is intended that the present invention covers the modifications and variations of the embodiments disclosed above provided that the modifications and variations come within the scope of any claims and their equivalents.

What is claimed is:

1. A method for organizing intelligence using a platform server for processing, comprising:
creating a query, using a business portal on a platform server within a system comprising a workflow engine, according to business rules that define-types of data to be collected from a plurality of end users;
transmitting the query, from a business portal on the server, over a network to a plurality of remote end user devices;
receiving, into the business portal, a plurality of end user responses to the query that are transmitted from the end user devices;
aggregating the received end user data, by the workflow engine, and storing the aggregated data for access by business users on a database;
displaying, on a graphical interface of a software dashboard installed on the platform server, a portion of the aggregated data, the dashboard configured to display the portion of data in real time as the data is received from the end users;
analyzing, using the workflow engine, the aggregated data collected from end users; and
building, using the workflow engine, a revised query for transmission to the plurality of end users based on the analyzed data from the query.

2. The method of claim 1, wherein the analyzing step further comprises analyzing end users' behavioral data based on the query responses and automatically segmenting end users into respondent groups based on the behavioral data.

3. The method of claim 1, wherein the creating the query step comprises creating a structured survey or free flow observation for transmission to other users.

4. The method of claim 3, further comprising:
automatically segmenting users into respondent groups based on a ranking factor of each user; and
determining, using the workflow engine, a confidence level of the responses based user rankings.

5. The method of claim 2, wherein the analyzing the behavioral data includes determining locations of each of the end users at response transmission time, and
wherein the building the revised query step comprises building the revised query for one of the respondent groups based on the response locations.

6. The method of claim 2, wherein the analyzing the behavioral data includes determining a speed of response transmission from each of the end users from a time of query transmission and automatically segmenting users into respondent groups based on the end users speed of response, and
wherein the building the revised query step comprises building the revised query for one of the respondent groups based on the end users speed of response.

7. The method of claim 1, further comprising:
providing end user participation statistics to the dashboard comprising scoring each end user based on a human behavioral factor, and
segmenting end users into groups based on each end user's score.

8. The method of claim 7, further comprising:
developing a confidence score for each user's communication, wherein a higher confidence score applies a greater weight to the reliability of the communication.

9. A system for organizing intelligence using a platform server for processing, comprising:
a business portal comprising a workflow engine on a server configured for creating a query according to business rules that define-types of data to be collected from a plurality of end users;
a mobile interface manager of the platform server configured for transmitting the query, from the business portal on the server, over a network to a plurality of remote end user devices;
the mobile interface manager further configured for receiving a plurality of end user responses to the query that are transmitted from the end user devices;
an aggregation manager of the server configured for aggregating the received end user data and storing the aggregated data for access by business users on a database;
a display displaying, on a graphical interface of a software dashboard installed on the platform server, a portion of the aggregated data, the dashboard configured to display the portion of data in real time as the data is received from the end users;
an analytics manager component of the server configured for analyzing the aggregated data collected from end users; and
a query manager component of the server configured for building, using the workflow engine, a revised query for transmission to the plurality of end users based on the analyzed data from the query.

10. The method of claim 9, wherein the analytics manager is further configured for collecting and analyzing end users' behavioral data based on the query responses and automatically segmenting end users into respondent groups based on the behavioral data.

11. The method of claim 9, wherein the creating the query step comprises creating a survey or observation for transmission to other users.

12. The method of claim 11, further comprising:
automatically segmenting users into respondent groups based on a ranking factor of each user; and
determining, using the workflow engine, a confidence level of the responses based user rankings.

13. The method of claim 10, wherein the analyzing manager is further configured for analyzing the behavioral data includes determining locations of each of the end users at response transmission time, and
wherein the query manager is further configured for building the revised query for one of the respondent groups based on the locations.

14. The method of claim 10, wherein the analyzing the behavioral data includes determining a speed of response transmission from each of the end users from a time of query transmission and automatically segmenting users into respondent groups based on the end users speed of response, and
wherein the query manager is further configured for building the revised query for one of the respondent groups based on the end users speed of response.

15. The method of claim 9, wherein the analytics manager is further configured for:
providing end user participation statistics to the dashboard comprising scoring each end user based on a human behavioral factor, and segmenting end users into groups based on each end user's score.

16. The method of claim 15, further comprising:
developing a confidence score for each user's communication, wherein a higher confidence score applies a greater weight to the reliability of the communication.

17. Logic encoded in non-transitory media that includes code for execution and when executed by a processor is operable to perform operations comprising:
creating a query, using a business portal on a platform server within an organizational intelligence system comprising a workflow engine, according to business rules that define-types of data to be collected from a plurality of end users;
transmitting the query, from a business portal on the server, over a network to a plurality of remote end user devices;
receiving, into the business portal, a plurality of end user responses to the query that are transmitted using an application on the end user devices;
aggregating the received end user data, by the workflow engine, and storing the aggregated data for access by business users on a database;
displaying, on a graphical interface of a software dashboard installed on the platform serve, a portion of the aggregated data, the dashboard configured to display the portion of data in real time as the data is received from end users;
analyzing, using the workflow engine, the aggregated data collected from end users; and
building, using the workflow engine, a revised query for transmission to the plurality of end users based on the analyzed data from the query.

18. The logic of claim 17, wherein the analyzing step further comprises analyzing end users' behavioral data based on the query responses automatically segmenting end users into respondent groups based on the behavioral data, and
wherein the building the revised query step comprises building the revised query for one of the respondent groups based on the behavioral data.

19. The logic of claim 17, wherein the creating the query step comprises creating a structured survey or free flow observation for transmission to other users.

20. The logic of claim 19, further comprising:
automatically segmenting users into respondent groups based on a ranking factor of each user; and
determining, using the workflow engine, a confidence level of the responses based user rankings.
